(19) United States
(12) Patent Application Publication
(10) Pub. No.: US 2017/0004298 A1
(43) Pub. Date: Jan. 5, 2017

(54) BINDING DEVICE INCLUDING SENSOR MODULE, SECURITY PROCESSING METHOD USING THE SAME, AND ELECTRONIC DEVICE INCLUDING BINDING DEVICE

(71) Applicant: SAMSUNG ELECTRONICS CO., LTD., GYEONGGI-DO (KR)

(72) Inventors: JUN WON LEE, GYEONGGI-DO (KR); DONG HUN KIM, SEOUL (KR); JIN SOO HA, SEOUL (KR); DA HWUN KIM, SEOUL (KR); TAE WOO KIM, SEOUL (KR); JIN SANG HWANG, SEOUL (KR)

(73) Assignee: SAMSUNG ELECTRONICS CO., LTD.

(21) Appl. No.: 15/202,278

(22) Filed: Jul. 5, 2016

(30) Foreign Application Priority Data
Jul. 2, 2015 (KR) 10-2015-0094863

(51) Int. Cl. G06F 21/32; G06F 21/62

(52) U.S. Cl. CPC G06F 21/32; G06F 21/6218

(57) ABSTRACT

An electronic device is provided. The electronic device includes a body and a binding device, the binding device extending from the body to surround a mounting target. The binding device includes a sensor module, and the sensor module includes at least one first sensor disposed on a first surface of the binding device to sense a portion of the user's body to collect sensing information.

### PRIORITY

This application claims priority under 35 U.S.C. §119(a) to a Korean Patent Application filed on Jul. 2, 2015, in the Korean Intellectual Property Office and assigned Serial No. 10-2015-0094863, the entire disclosure of which is incorporated herein by reference.

### BACKGROUND

1. Field of the Disclosure

The present disclosure relates generally to a binding device having a sensor module.

2. Description of the Related Art

In recent years, devices that may be mounted on parts of the bodies of the users or various structures have been rapidly developed. Such a wearable electronic device may generally include a body, and a binding device extending from the body by a specific length and fixed to a part of the body of the user or various structures.

However, existing electronic devices require the user to perform a user input operation for a separate authentication from a mounting operation of the electronic device, in relation to security processing. For example, existing electronic devices may allow the user to input a password or a pattern for authentication through an input unit such as a touch screen, separately from an operation of mounting the electronic device on a part of the body of the user or various structures. Further, existing electronic devices may require the user to perform a user input operation for a locking function separately even when the electronic device is dismounted. The separate user input operations may be recognized as bothersome operations, and may lower the utility of a security function provided by the electronic device.

### SUMMARY

The present disclosure has been made to address at least the above-mentioned problems and/or disadvantages and to provide at least the advantages described below.

Accordingly, an aspect of the present disclosure is to provide a binding device that includes a sensor module for collecting sensing information to allow an electronic device to collect the sensing information when the electronic device is mounted or dismounted, a security processing method using the same, and an electronic device including the binding device.

Accordingly, another aspect of the present disclosure is to provide a binding device that includes a sensor module provided in the binding device when a body of a separable electronic device detachably provided in the binding device and the binding device are coupled to each other and a connection interface for connection with the body, a security processing method using the same, and an electronic device including the binding device.

Accordingly, another aspect of the present disclosure may make a separate user input operation for a security function unnecessary by collecting sensing information related to security processing when the electronic device is mounted or dismounted through a sensor module included in a binding device, thereby making it possible to increase the utility of the security function.

Accordingly, another aspect of the present disclosure provides a structure that may replace the body or the binding device by providing a connection interface for connection of the body and the sensor module included in the binding device.

Accordingly, another aspect of present disclosure supports connection of additional elements included in the binding device through a connection interface.

In accordance with an aspect of the present disclosure, an electronic device is provided. The electronic device includes a body and a binding device extending from the body to surround a mounting target. The binding device includes a sensor module, and the sensor module includes at least one first sensor disposed on a first surface of the binding device to sense a portion of the user's body to collect sensing information.

In accordance with another aspect of the present disclosure, a binding device is provided. The binding device includes a body seating part on which a body of the electronic device is seated, a strap extending from the body seating part to surround a mounting target, a sensor module disposed in the strap, and a body connector disposed in an area of the strap, connected at a first end to the sensor module, and exposed to the outside through an opening formed on one surface of the body seating part, where the body connector is to be connected at a second end to the body of the electronic device.

In according with another aspect of the present disclosure, a security processing method of an electronic device is provided. The method includes sensing biometric information of a user by at least one sensor included in a sensor module, where the at least one sensor is disposed on a first surface of a binding device connected to a body of the electronic device, analyzing the sensed biometric information, and performing a user authenticating function based on the analyzed sensed biometric information.

### BRIEF DESCRIPTION OF THE DRAWINGS

The above and other aspects, features, and advantages of the present disclosure will be more apparent from the following description taken in conjunction with the accompanying drawings, in which:

FIG. 1A is a plan view of an electronic device including a binding device having a sensor module, according to an embodiment of the present disclosure;

FIG. 1B is a perspective view of an electronic device including a binding device in a state in which the binding device is bound, according to an embodiment of the present disclosure;

FIG. 2A is a plan view of a binding device including a sensor module, according to an embodiment of the present disclosure;

FIG. 2B is a perspective view of a binding device including a sensor module in a state in which the binding device is bound, according to an embodiment of the present disclosure;

FIG. 3 illustrates a configuration in which a sensor module is disposed in a binder of a binding device, according to an embodiment of the present disclosure;

FIG. 4 illustrates a configuration in which a sensor module is disposed in a binder of a separable body type binding device, according to an embodiment of the present disclosure;

FIG. 5 illustrates a binding device, according to an embodiment of the present disclosure;

FIG. 6 is a block diagram of an electronic device, according to an embodiment of the present disclosure;

FIG. 7 is a flowchart of a security method of an electronic device when the electronic device is mounted on a user's body, according to an embodiment of the present disclosure; and

FIG. 8 is a flowchart of a security method of an electronic device when the electronic device is demounted from a user's body.

### DETAILED DESCRIPTION OF EMBODIMENTS OF THE PRESENT DISCLOSURE

Hereinafter, various embodiments of the present disclosure will be described with reference to the accompanying drawings. Accordingly, those of ordinary skill in the art will recognize that modifications, equivalents, and/or alternatives of the various embodiments described herein can be made without departing from the scope and spirit of the present disclosure. With regard to description of drawings, similar components may be marked by similar reference numerals.

In the present disclosure, the expressions “have”, “may have”, “include”, “comprise”, “may include”, and “may comprise” indicate the existence of corresponding features (e.g., such as numeric values, functions, operations, or components) but do not exclude the presence of additional features.

In the present disclosure, expressions such as, “A or B”, “at least one of A or/and B”, and “one or more of A or/and B”, may include any and all combinations of one or more of the associated listed items. For example, the terms “A or B”, “at least one of A and B”, and “at least one of A or B” may refer to the case (1) where A is included, (2) where B is included, or (3) where both A and B are included.

Terms, such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing from the scope of the present disclosure, a first element may be referred to as a second element, and similarly, a second element may be referred to as a first element.

It will be understood that when an element (for example, a first element) is referred to as being (operatively or communicatively) “coupled with/to” or “connected to” another element (for example, a second element), it can be directly coupled with/to or connected to the other element or an intervening element (for example, a third element) may be present. In contrast, when an element (for example, a first element) is referred to as being “directly coupled with/to” or “directly connected to” another element (for example, a second element), it should be understood that there are no intervening element (for example, a third element).

According to the situation, the expression “configured to” used herein may be used interchangeably with, for example, the expression “suitable for”, “having the capacity to”, “designed to”, “adapted to”, “made to”, or “capable of”. The term “configured to (or set to)” does not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

The terms used herein are used to describe specific embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning as that generally understood by a person skilled in the art to which the present disclosure pertains. It will be further understood that terms, which are defined in a dictionary and commonly used, should also be interpreted as is customary in the relevant related art and not in an idealized or overly formal manner unless expressly so defined herein. In some cases, even if terms are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), MP3 players, mobile medical devices, cameras, and wearable devices. The wearable devices may include accessories (for example, watches, rings, bracelets, ankle bracelets, glasses, contact lenses, or head-mounted devices (HMDs)), cloth-integrated types (for example, electronic clothes), body-attached types (for example, skin pads or tattoos), or implantable types (for example, implantable circuits).

In some embodiments of the present disclosure, the electronic device may be one of home appliances. The home appliances may include, for example, at least one of a digital versatile disk (DVD) player, an audio, a refrigerator, an air conditioner, a cleaner, an oven, a microwave oven, a washing machine, an air cleaner, a set-top box, a home automation control panel, a security control panel, a TV box (for example, Samsung HomeSync™ Apple TV™, or Google TV™), a game console (for example, Xbox™ or PlayStation™) an electronic dictionary, an electronic key, a camcorder, or an electronic panel.

In another embodiment of the present disclosure, the electronic device may include at least one of various medical devices (for example, various portable medical measurement devices (a blood glucose meter, a heart rate measuring device, a blood pressure measuring device, and a body temperature measuring device), a magnetic resonance angiography (MRA) device, a magnetic resonance imaging (MRI) device, a computed tomography (CT) device, a photographing device, and an ultrasonic device), a navigation system, a global navigation satellite system (GNSS), an event data recorder (EDR), a flight data recorder (FDR), a vehicular infotainment device, an electronic device for vessels (for example, a navigation device for vessels and a gyro compass), an avionics device, a security device, a vehicular head unit, an industrial or home robot, an automatic teller machine (ATM), a point of sales (POS) device, or an Internet of Things (IoT) device (for example, a light bulb, various sensors, an electricity or gas meter, a spring cooler device, a fire alarm device, a thermostat, an electric pole, a toaster, a sporting apparatus, a hot water tank, a heater, and a boiler).

According to some embodiments of the present disclosure, the electronic device may include at least one of a furniture or a part of a building/structure, an electronic board, an electronic signature receiving device, a projector, or various measurement devices (for example, a water service, electricity, gas, or electric wave measuring device).

In various embodiments of the present disclosure, the electronic device may be one or a combination of the aforementioned devices. The electronic device may be a flexible electronic device. Further, the electronic device is not limited to the aforementioned devices, but may include new electronic devices produced due to the development of new technologies.

Hereinafter, electronic devices according to an embodiment of the present disclosure will be described with reference to the accompanying drawings. The term “user” used herein may refer to a person who uses an electronic device or may refer to a device (for example, an artificial intelligence electronic device) that uses an electronic device.

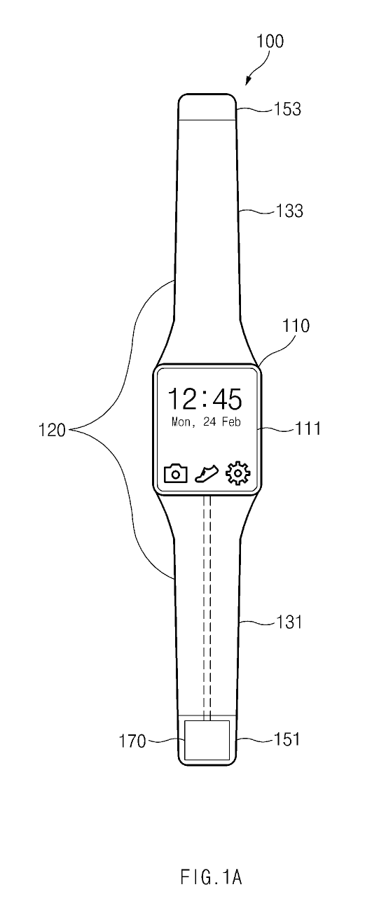

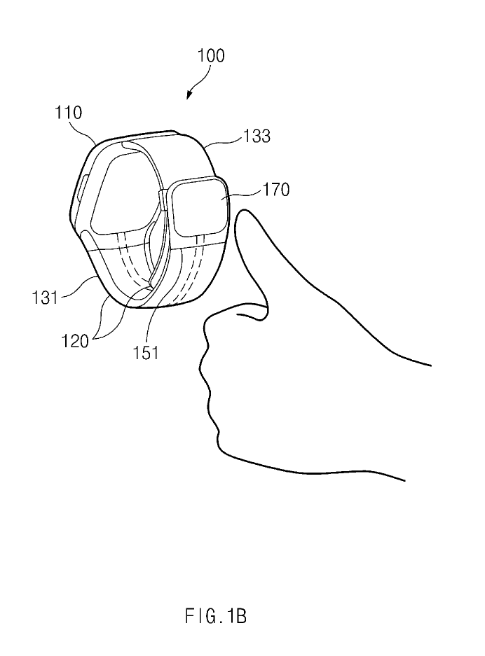

FIG. 1A is a plan view of an electronic device including a binding device having a sensor module, according to an embodiment of the present disclosure. FIG. 1B is a perspective view of an electronic device including a binding device in a state in which the binding device is bound, according to an embodiment of the present disclosure.

Referring to FIGS. 1A and 1B, an electronic device 100 is shown. The electronic device 100 includes a body 110 and a binding device 120. The body 110 is a device for performing functions of the electronic device 100, and may include at least one piece of software or hardware. For example, the body 110 may include a processor, a memory, or a display 111.

The processor 110 may be disposed inside the body 110, and may execute operations or data processing related to the control and/or communication of at least one other element of the electronic device 100. The memory may store a command or data related to at least one other element of the electronic device 100. The memory may be disposed inside the body 110, or may be connected to the body 110 as a separate device. The display 111 may display various data (for example, a text, an image, a video, an icon, or a symbol). The display 111 may include a touch screen and receive an input, for example, a touch, a gesture, a proximity, or a hovering input using an electronic pen or the user's body.

The binding device 120 is connected to the body 110, and extends from the body 110 by a specific length in a specific direction. The binding device 120 may function to fix the electronic device 100 to a part of the body of the user or various structures. The binding device 120 includes a first strap 131, a second strap 133, a first binder 151, a second binder 153, and a sensor module 170.

The first strap 131 and the second strap 133 may function to surround a mounting target (for example, a wrist of the user). For example, at least one of the first strap 131 and the second strap 133 may be formed of a flexible material, and may have a form of a band having a specific width and a specific length to surround the mounting target. According to various embodiments, the first strap 131 and the second strap 133 may extend from the body 110 in different directions. For example, the second strap 133 may be connected to a surface of side surfaces of the body 111, which is opposite to a surface to which the first strap 131 is connected, and may extend in a direction opposite to the first strap 131.

The first binder 151 and the second binder 153 may be formed in specific areas of the first strap 131 and the second strap 133, respectively. The first binder 151 and the second binder 153 may bind the first strap 131 and the second strap 133. According to an embodiment, the first binder 151 may be formed at one of opposite peripheries of the first strap 131, which is situated on a side that is not connected to the body 110. The second binder 153 may be formed at one of opposite peripheries of the second strap 133, which is situated on a side that is not connected to the body 110.

According to various embodiments, the first binder 151 and the second binder 153 may be paired to be connected to each other such that the first strap 131 and the second strap 133 are connected to each other to be fixed to the mounting target. The first binder 151 and the second binder 153 may be physically connected to each other. For example, the first binder 151 and the second binder 153 may be a latch and a groove, a hook and a loop, adhesive fabrics, or buckles. The first binder 151 and the second binder 153 may be magnetically connected to each other. For example, the first binder 151 and the second binder 153 may include a magnetic material. The configurations and types of the first binder 151 and the second binder 153 are not limited thereto, and may include various configurations and types that may be connected and fixed to each other.

According to various embodiments, the second strap 133 may be excluded from the configuration of the binding device 120. In this case, the second binder 153 may be connected to a surface of side surfaces of the body 110, which is opposite to a surface to which the first strap 131 is connected. Further, the second binder 153 may be also excluded from the configuration of the binding device 120, and the first binder 151 may be connected to a surface of the side surfaces of the body 110, which is opposite to the surface to which the first strap 131 is connected. According to various embodiments, the first binder 151 and the second binder 153 may be integrally connected to each other. According to various embodiments, the first binder 151 and the second binder 153 may include a connection length adjusting device such that a connection length of the first strap 131 and the second strap 133 may be adjusted.

The sensor module 170 may measure a physical quantity or detect an operational state of the electronic device 100, and may convert the measured or detected information to an electrical signal. For example, the sensor module 170 may include a fingerprint recognition sensor, a biometric sensor, or a proximity sensor. According to various embodiments, the sensor module 170 may collect biometric information from the user. For example, the sensor module 170 may collect fingerprint information of the user through the fingerprint recognition sensor. Further, the sensor module 170 may collect vein information or electrocardiogram information through the biometric sensor. The sensor module 170 may detect the existence of an object that approaches a detection surface or an object that is present in the vicinity of the detection surface through the proximity sensor.

According to various embodiments, the sensor module 170 may be disposed in a specific area of the binding device 120. The sensor module 170 may be disposed in a specific area of the first strap 131. FIGS. 1A and 1B illustrate a configuration in which the sensor module 170 is disposed in the first binder 151 provided at one end of the first strap 131. One or more different sensors included in the sensor module 170 may be disposed at different locations of the binding device 120. As an example, the proximity sensor may be disposed on a surface of the first binder 151, which faces a mounting target, and the fingerprint recognition sensor or the biometric sensor may be disposed on a surface of the first binder 151, which is opposite to the surface of the first binder 151 on which the proximity sensor is disposed. The sensor module 170 may be electrically connected to the body 110 through at least one connection circuit disposed inside the binding device 120.

According to various embodiments, the fingerprint recognition sensor or the biometric sensor may be disposed on a surface of the binding device 120, which is opposite to a surface of the binding device 120 that faces a mounting target (for example, a wrist of the user). Through the arrangement structure, as illustrated in FIG. 1B, the fingerprint recognition sensor or the biometric sensor may make contact with a part of the body of the user when the electronic 100 is mounted on the body of the user.

According to various embodiments, the sensor module 170 may deliver fingerprint information, vein information, electrocardiogram information, or the like sensed through contact with a part of the body of the user to the body 110 based on the fingerprint recognition sensor or the biometric sensor, when the electronic device 100 is mounted on the body of the user. In this regard, the body 110 may perform a user authentication function by analyzing sensing information delivered from the sensor module 170. For example, the body 110 may identify whether the user is an authenticated person by analyzing the sensing information, and may perform security processing such as unlocking of the electronic device 100 when the user is an authenticated person. If the authentication of the user is successful, the electronic device 100 may perform a payment based on a payment device (for example, a smartcard) embedded or mounted in a specific area of the body 110 or the binding device 120. Further, if the authentication of the user is successful, the electronic device 100 may perform a payment by using card information of the user stored in the body 110 or the binding device 120.

According to various embodiments, the proximity sensor and the like may be disposed on a surface of the binding device 120, which faces a mounting target. Through the arrangement structure, the proximity sensor or the like may detect a proximity of the mounting target.

According to various embodiments, the sensor module 170 may deliver sensing information detected based on the proximity sensor or the like to the body 110. In this regard, the body 110 may determine whether the electronic device 100 is demounted from the mounting target by analyzing the sensing information delivered from the sensor module 170. The body 110 may perform security processing such as a locking function when the electronic device 100 is demounted.

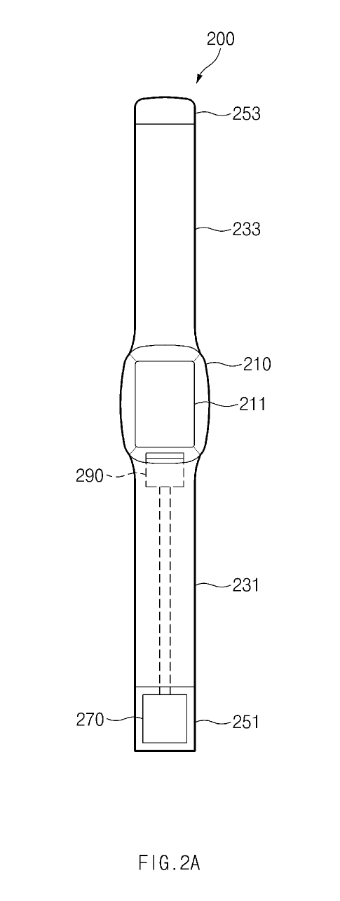

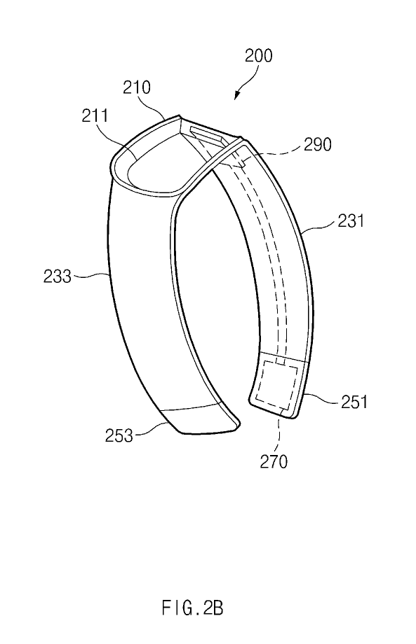

FIG. 2A is a plan view of a binding device including a sensor module, according to an embodiment of the present disclosure. FIG. 2B is a perspective view of a binding device including a sensor module in a state in which the binding device is bound, according to an embodiment of the present disclosure.

Referring to FIGS. 2A and 2B, a binding device 200 is shown. According to various embodiments, the binding device 200 of FIGS. 2A and 2B may have a configuration that is the same as or similar to the binding device of the electronic device 100 of FIGS. 1A and 1B. The binding device 200 of FIGS. 2A and 2B has a configuration in which the body 110 shown in FIGS. 1A and 1B is not included.

Referring to FIGS. 2A and 2B, the binding device 200 includes a body seating part 210, a first strap 231, a second strap 233, a first binder 251, a second binder 253, a sensor module 270, and a body connector 290. The body seating part 210 may be an area in which the body 110 is seated. According to various embodiments, the body seating part 210 may have a width, a height, and a depth in a specific area (for example, a central area) of the binding device 200. The width, the height, and the depth of the body seating part 210 may have the sizes that are the same as or similar to those of the width, the height, and the depth of the body 110, respectively. The body seating part 210 may be recessed in a direction in which the body 110 faces the mounting target. For example, the body seating part 210 may be recessed such that the width and the height thereof gradually decrease in the facing direction.

According to various embodiments, a coupling device that functions to seat the body 110 in at least one area of the body seating part 210 to couple the body 110 is provided. For example, at least one groove or bump may be formed in a specific area of the body seating part 210. Further, at least one slide lock button may be provided in a specific area of the body seating part 210. The slide lock button may be a button that may set a lock/unlock state through an operation (slide operation) of moving in a specific direction while an operating part thereof is pushed. A portion of the slide lock button may be disposed in the body seating part 210 and another portion thereof may be disposed in the body 110.

According to various embodiments, the body seating part 210 may include at least one opening 211. The opening 211 may have a width and a height that are the same as or similar to the width and the height of the body 110. The opening 211 may have a width and a height that are smaller than the width and the length of the body 110 by specific sizes. This is so the body 110 can be prevented from passing through the opening 211 without being seated on the body seating part 210. According to various embodiments, if the body is seated on the body seating part 210, an area of the rear surface (a surface that faces a mounting target) of the body 110 may be exposed to the outside through the opening 211. Through this, at least one functional module (for example, an external power connecting interface) disposed on the rear surface of the body 110 may be used even while the body 110 is coupled to the binding device 200.

The first strap 231 and the second strap 233 may have configurations that are the same as or similar to those of the first strap 131 and the second strap 133, respectively, of FIG. 1A. In the structure the binding device 200, a body connector 290 is disposed inside the first strap 231. The body connector 290 may function to connect the binding device 200 and the body 110. According to an embodiment, the body connector 290 may function as an interface that electrically connects the sensor module 270 disposed in a specific area of the binding device 200 and the body 110. For example, the body connector 290 may be connected to the sensor module 270 through at least one connection circuit disposed inside the first strap 231, and at least an area (for example, a surface in contact with the body seating part 210) of the body connector 290 may be exposed to the outside and may be connected to the body 110. The body connector 290 may be a pogo connector including at least one pogo pins.

The first binder 251 and the second binder 253 may have configurations that are the same as or similar to those of the first binder 151 and the second binder 153, respectively, of FIG. 1A. The first binder 251 may be formed in a specific area of the first strap 231, for example, at a periphery of the first strap 231 on a side on which the first strap 231 is not connected to the body seating part 210. Further, the second binder 253 may be formed in a specific area of the second strap 233, for example, at a periphery of the second strap 233 on a side on which the second strap 231 is not connected to the body seating part 210.

The sensor module 270 may have a configuration that is the same as or similar to that of the sensor module 170 of FIG. 1A. While the sensor module 170 of FIG. 1A may be directly connected to the body 110 of FIG. 1A, the sensor module 270 of FIG. 2A may be connected to the body through the body connector 290. According to various embodiments, the sensor module 270 may be disposed at least one of the first strap 231 or the second strap 233. For example, the fingerprint recognition sensor included in the sensor module 270 may be disposed in a specific area of the first strap 231, and the proximity sensor included in the sensor module 270 may be disposed in a specific area of the second strap 233. At least a portion of the fingerprint recognition sensor or the proximity sensor may be disposed to be exposed to the outside. Further, a detection surface of the fingerprint recognition sensor or a detection surface of the proximity sensor may be exposed to the outside to contact or approach a detection target.

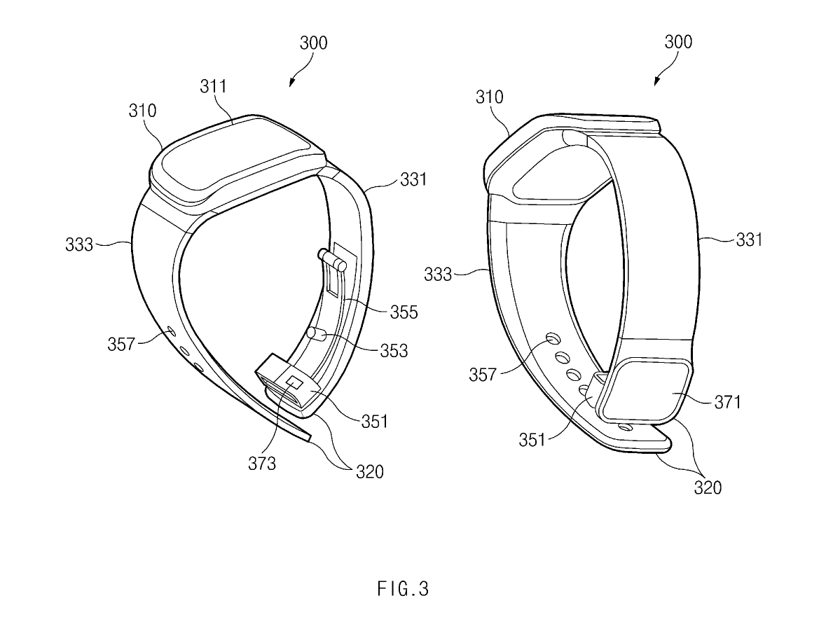

FIG. 3 illustrates a configuration in which a sensor module is disposed in a binder of a binding device, according to an embodiment of the present disclosure.

Referring to FIG. 3, the electronic device 300 includes a body 310 and a binding device 320 extending from the body 310 by a specific length in a specific direction. The body 310, for example, may be the body of a smartwatch, and may have a processor, a memory, a communication module, and a battery therein. Further, the body 310 includes a display 311. The display 311 may be a touch screen, and may display various data to the user and may receive a touch, a gesture, a proximity, or a hovering input from the user.

The binding device includes at least one strap extending from the body 310 by a specific length in a specific direction to surround a mounting target, and at least one binder performing a binding function such that the strap may be fixed while surrounding the mounting target. The strap includes a first strap 331 extending from one surface of the body 310 by a specific length, and a second strap 333 connected to a surface of the body 310, which is opposite to a surface to which the first strap 331 is connected, and extending by a specific length in a direction opposite to the extension direction of the first strap 331. The binder may be disposed in a specific area of the strap. FIG. 3 illustrates a state in which a first binder 351, a second binder 353, and a third binder 355 are disposed on a surface of the first strap 331, which faces a mounting target of the first strap 331, and a fourth binder 357 is disposed in a specific area of the second strap 333.

In various embodiments, as illustrated in FIG. 3, the first binder 351, the second binder 353, and the third binder 355 may be buckles, and the fourth binder 357 may have at least one hole. The first binder 351 may include an opening having a specific width and a specific height. In this case, if a portion of the second strap 333 is inserted through the opening, a portion of the second strap 333 may overlap a surface of the first strap 331, which is opposite to a surface that faces a mounting target.

According to an embodiment, the second binder 353 may include a bump having a specific shape. The second binder 353 may be bound to the fourth binder 357 to fix a connection length of the first strap 331 and the second strap 333. For example, the bump of the second binder 353 may be inserted into and fixed to the hole of the fourth binder 357. The user may adjust and fix the connection length through the second binder 353 and the fourth binder 357 such that the connection length is suitable for the circumference of a wrist when the electronic device 300 is mounted on the wrist.

According to an embodiment, the third binder 355 may be a foldable fixing device. For example, the electronic device 300 may change a mounting radius through the third binder 355. Accordingly, the electronic device 300 may be easily separated from the mounting target by unfolding the third binder 355 even in a state in which the first strap 331 and the second strap 333 are bound to each other, and to the contrary, the electronic device 300 may be fixed to the mounting target by folding the third binder 355 while the electronic device 300 is mounted on the mounting target.

According to various embodiments, a sensor module may be disposed in a specific area of the binding device 320. The sensor module may be disposed in a binder of the binding device. For example, a first sensor 371 and a second sensor 373 may be disposed in a buckle. The first sensor 371 may be a fingerprint recognition sensor disposed on a surface of the buckle, which is opposite to a surface that faces the mounting target, and the second sensor 373 may be a proximity sensor disposed on a surface of the buckle, which faces the mounting target. FIG. 3 illustrates a configuration in which the fingerprint recognition sensor is disposed on a surface of the buckle, which is opposite to a surface that faces the mounting target such that a detection surface is exposed to the outside, and the proximity sensor is disposed on a surface (for example, an area of the first binder 351) of the buckle, which faces the mounting target such that a detection surface is exposed to the outside.

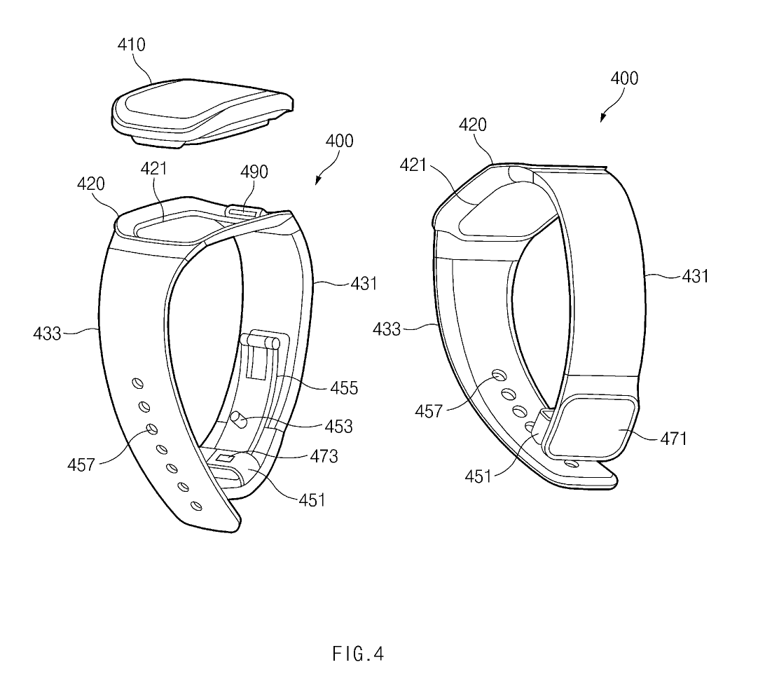

FIG. 4 illustrates a configuration in which a sensor module is disposed in a binder of a separable body type binding device, according to an embodiment of the present disclosure.

Referring to FIG. 4, a separable body type binding device 400 is shown. The binding device 400 may be separated from a body 410. According to various embodiments, the binding device 400 may have a configuration that is the same as or similar to the binding device 320 of FIG. 3. The binding device 400 includes a body seating part 420 on which the body 410 may be seated in a specific area. The body seating part 420 may have a width, a height, and a thickness that are the same as or similar to those of the body 410. Further, the body seating part 420 includes a coupling device that allows the body 410 to be seated in and coupled to a specific area. For example, at least one slide lock button may be provided in a specific area of the body seating part 420. According to various embodiments, the body seating part 420 may include at least one opening 421 in a specific area thereof. The opening 421 may have a width and a height that are smaller than those of the body 410 by specific sizes.

The binding device 400 includes a first strap 431 connected to one side surface of the body seating part 420 and extending from the surface of the body seating part 420 by a specific length in a specific direction, and a second strap 433 connected to a side surface of the body seating part 420, which is opposite to the surface of the body seating part 420 to which the first strap 431 is connected, and extending in a direction opposite to the extension direction of the first strap 431. According to various embodiments, a first binder 451, a second binder 453, and a third binder 455 may be disposed in a specific area of the first strap 431. Further, a fourth binder 457 having at least one hole may be disposed in a specific area of the second strap 433. The first binder 451, the second binder 453, and the third binder 455 may form a buckle.

According to various embodiments, a first sensor 471 and a second sensor 473 may be disposed in a specific area of the buckle. For example, the first sensor 471 may be disposed such that a detection surface is disposed on a surface of the buckle, which is opposite to a surface of the buckle which faces a mounting target. Further, the second sensor 473 may be disposed such that the detection surface is exposed to a surface of the first binder 451 which faces the mounting target.

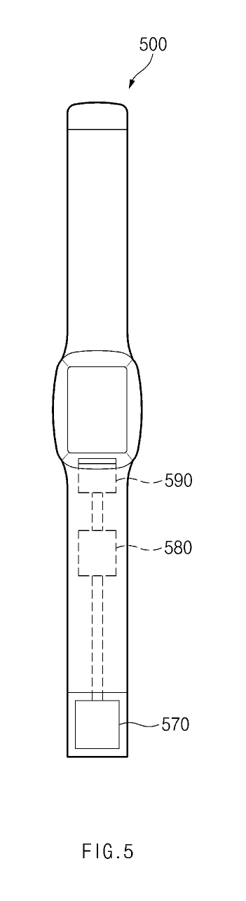

FIG. 5 illustrates a binding device, according to an embodiment of the present disclosure.

Referring to FIG. 5, binding device 500 is shown. The binding device 500 may include additional elements in a specific area. According to an embodiment, the binding device 500 may further include a battery 580 on the inside thereof. The battery may function to supply electric power to the sensor module 570 included in the binding device 500 and the body 410 coupled to the binding device 500.

According to various embodiments, the additional elements may be connected to a body connector 590 or another element included in the binding device 500 according to functions thereof. For example, the battery 580 disposed inside the binding device 500 may be connected to the sensor module 570 included in the binding device 500 and the body connector 590 through at least one connection circuit. In some embodiments, the battery 580 may be connected only to the body connector 590. In this case, the sensor module 570 may be connected to the body connector 590 through another connection circuit.

According to various embodiments, the battery 580 is disposed in the binding device 500, and when the sensor module 570 receives electric power from the battery 580, the binding device 500 may collect biometric information of the user by using the sensor module 570 while the body is not coupled. For example, when the binding device 500 is mounted on a part (for example, a wrist) of the body of the user while the body is separated from the binding device 500, the sensor module 570 may collect biometric information (for example, fingerprint information) by sensing a part (for example, a finger) of the body of the user, which is in contact with the sensor module 570 as the binding device 500 is mounted. Further, the binding device 500 may deliver the collected biometric information to the body if the body is coupled. Through this, the body may perform a user authenticating function by analyzing the biometric information.

According to various embodiments, when the binding device 500 is dismounted from a mounting target while the body is separated from the binding device 500, the sensor module 570 may receive electric power from the battery 580 and measure the location of the mounting target. Further, the binding device 500 may deliver the measured information to the body if the body is coupled. In some embodiments, the binding device 500 may deliver the measured information to the body separated from the binding device 500 through a communication module additionally disposed inside the binding device 500. Through this, the body may perform security processing such as locking of a screen, by analyzing the measured information.

According to various embodiments, the additional elements are not limited to the battery 580. The additional element may be various types of functional modules necessary for performance of the functions of the body. For example, the additional elements includes a storage module such as a memory.

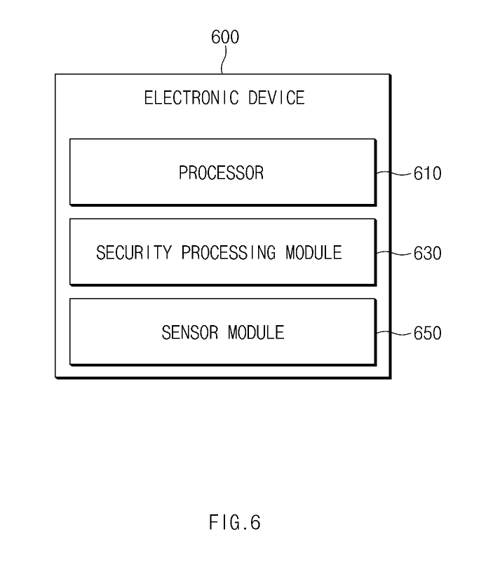

FIG. 6 is a block diagram of an electronic device, according to an embodiment of the present disclosure.

Referring to FIG. 6, an electronic device 600 is shown. The electronic device 600 includes a processor 610, a security processing module 630, and a sensor module 650. FIG. 6 illustrates only main elements of the electronic device 600, which are related to security processing. The elements of the electronic device 600 are not limited thereto, but may include at least one additional element.

The processor 610 may execute operations or data processing related to the control and/or communication of at least one other component of the electronic device 600. The processor 610 may include one or more of a central processing unit (CPU), an application processor (AP), or a communication processor (CP). According to various embodiments, the processor 610 may process signals related to security processing. For example, the processor 610 may deliver sensing information collected by the sensor module 650 to the security processing module 630, or may perform related security processing by analyzing the collected sensing information. The processor 610 may be disposed inside the body 110 of the electronic device 600.

The security processing module 630 may perform security processing of the electronic device 600. For example, the security processing module 630 may perform a security function, such as user authentication, screen locking, screen unlocking, or switching to a sleep state of the electronic device 600. In relation to the performance of the security function, the security processing module 630 may analyze sensing information collected by the sensor module 650. For example, the security processing module 630 may analyze fingerprint information of the user collected by a fingerprint recognition sensor. Further, the security processing module 630 may analyze vein information or electrocardiogram information collected by the biometric sensor. According to various embodiments, the security processing module 630 may analyze the sensing information collected by a proximity sensor to determine existence of an object that approaches a detection surface or that is located in the vicinity of the detection surface.

According to various embodiments, the security processing module 630 may determine whether the user of the electronic device 600 is an authenticated person. For example, the security processing module 630 may perform a user authenticating function based on the analysis result of the sensing information. The security processing module 630 may determine whether the user is an authenticated person based on the analysis result of the fingerprint information of the user collected through the fingerprint recognition sensor. In this regard, the security processing module 630 may collect fingerprint information of an authenticated user from a memory included in the electronic device 600 or an external electronic device connected to the electronic device 600 through a wired/wireless communication, and may compare the fingerprint information of the authenticated person with the fingerprint information collected through the fingerprint recognition sensor.

According to various embodiments, the security processing module 630 may determine whether the electronic device 600 is dismounted from a mounting target (for example, a wrist of the user). For example, the security processing module 630 may determine whether the electronic device 600 is dismounted based on the analysis result of the sensing information. The security processing module 630 may determine whether the electronic device 600 is dismounted from the mounting target, based on the analysis result of the sensing information collected by a proximity sensor. For example, if it is determined that the detection surface of the proximity sensor and a detected portion of the mounting target is separated from each other by a specific distance or more, the security processing module 630 may determine that the electronic device 600 is dismounted.

According to various embodiments, if it is determined that the user of the electronic device 600 is an authenticated person in a sleep state or a screen locking state of the electronic device 600, the security processing module 630 may release a sleep state or unlock the screen. For example, if the user is successfully authenticated, the security processing module 630 may allow the user to use the functional modules included in the electronic device 600, and may unlock a screen of the display 111 included in the electronic device 600 or a display of an external electronic device connected to the electronic device 600 through a wired/wireless communication.

According to various embodiments, if the electronic device 600 is dismounted from the mounting target, the security processing module 630 may switch the electronic device 600 into a sleep state or lock the screen. When the electronic device 600 is dismounted, the security processing module 630 may turn off the power source of the electronic device 600.

According to various embodiments, the security processing module 630 may be disposed inside the body of the electronic device 600. The security processing module 630 may be included in the processor 610. Further, at least some functions of the security processing module 630 may be performed by the processor 610.

The sensor module 650 may measure a physical quantity or sense an operating state of the electronic device 600, and may convert the measured or sensed information into an electric signal. For example, the sensor module 650 may include a fingerprint recognition sensor, a biometric sensor, or a proximity sensor. According to various embodiments, the sensor module 170 may collect fingerprint information, vein information, or electrocardiogram information from the user. Further, the sensor module 170 may measure a spacing distance from the mounting target.

According to various embodiments, the sensor module 650 may deliver the sensed information to at least one of the processor 610 or the security processing module 630. The sensor module 650 may be disposed in the binding device 200 of the electronic device 600. In some embodiments, at least one sensor included in the sensor module 650 may be disposed in the body of the electronic device 600. For example, at least one of a biometric sensor or a proximity sensor included in the sensor module 650 may be disposed on a surface of the body, which faces a mounting target.

According to various embodiments, the sensor module 650 may further include a control circuit for controlling one or more sensors included therein. The electronic device 600 may further include a processor configured to control the sensor module 650 as a part of or separately from the processor 610, and may control the sensor module 650 while the processor 610 is in a sleep state. Further, the sensor module 650 may be always on.

As described above, according to various embodiments, there is provided an electronic device including a body, and a binding device extending from the body to surround a mounting target. The binding device may include a sensor module. The sensor module may include at least one first sensor disposed on a first surface of the binding device, which is opposite to a second surface of the binding device that faces the mounting target, to sense a portion of the user's body to collect sensing information.

According to various embodiments, the binding device includes a buckle, and the sensor module may be disposed in the buckle.

According to various embodiments, the sensor module may include at least one second sensor disposed on the second surface of the binding device, which faces the mounting target to measure a distance between the sensor module and the mounting target at a time interval, and the body may determine whether the electronic device is demounted based on the measured distance between the sensor module and the mounting target.

As described above, according to various embodiments, there is provided a binding device for an electronic device, including a body seating part on which a body of the electronic device is seated, a strap extending from the body seating part to surround a mounting target, a sensor module disposed in the strap, and a body connector disposed in an area of the strap, connected at a first end to the sensor module through at least one connection circuit, and exposed to the outside through an opening formed on one surface of the body seating part, wherein the body connector is to be connected at a second end to the body of the electronic device.

According to various embodiments, the sensor module may be disposed in a buckle formed in an area of the strap.

According to various embodiments, the sensor module may include a fingerprint recognition sensor, and the fingerprint recognition sensor may be disposed on a surface of the buckle, which is opposite to a surface of the buckle that faces the mounting target.

According to various embodiments, the sensor module may include a proximity sensor, and the proximity sensor is disposed on a surface of the buckle, which faces the mounting target.

According to various embodiments, a battery may be disposed in the strap, and the battery may be connected to at least one of the body connector and the sensor module through at least one connection circuit.

According to various embodiments, the body connector may be a pogo connector including at least one pogo pin.

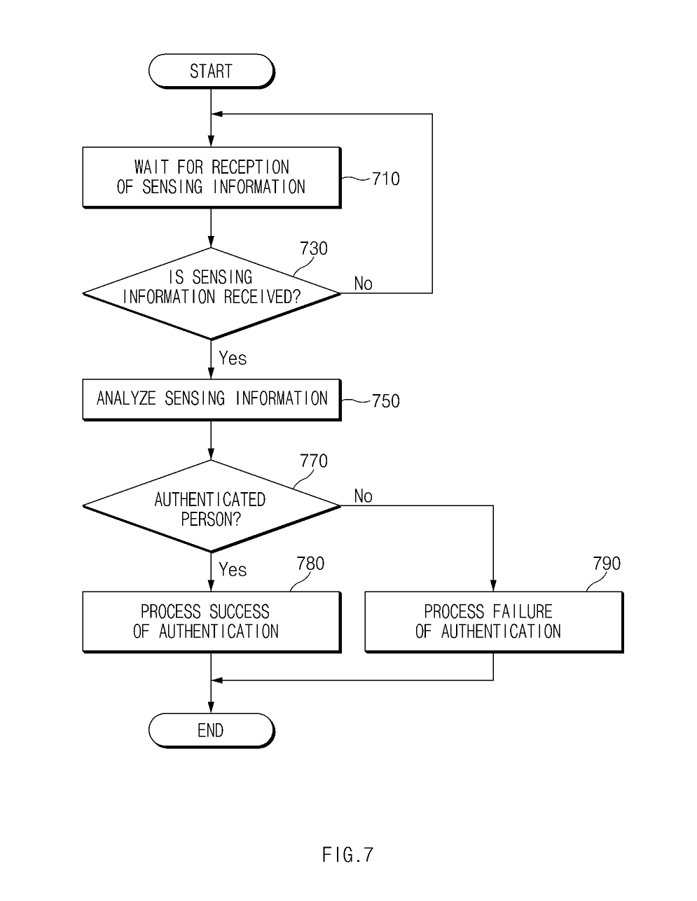

FIG. 7 is a flowchart of a security method of an electronic device when the electronic device is mounted on a user's body, according to an embodiment of the present disclosure.

Referring to FIG. 7, when being mounted, the electronic device 100 may perform a user authenticating function through the sensor module 170 disposed in a specific area of the binding device. For example, if the user pushes a fingerprint recognition sensor disposed in a buckle of the electronic device to put on the electronic device, the fingerprint recognition sensor may collect fingerprint information of the user at the same time when the electronic device is mounted or at a time interval. In this way, the electronic device may perform a user authenticating function by analyzing the collected fingerprint information.

In step 710, the electronic device may wait for reception of sensing information. According to an embodiment, the sensor module may be turned on at a time interval. The sensor module may be always on.

In step 730, the electronic device may determine whether sensing information is received. For example, the electronic device may determine whether the sensor module has collected sensing information as a part of the body of the user makes contact with the sensor module disposed in a specific area of the binding device so that the user puts on the electronic device.

According to various embodiments, when sensing information is not received, the electronic device may return to step 710. If the sensing information is received, the electronic device may analyze the sensing information in step 750. If fingerprint information is received as the sensing information, the electronic device may analyze the fingerprint information. For example, the electronic device may analyze the lengths, the directions, or specific points (for example, a point at which ridge lines are branched, a point at which ridge lines are connected to each other, or a point at which a ridge line ends) of the ridge lines included in the fingerprint information.

In step 770, the electronic device may determine whether the user is an authenticated person, based on the analysis result of the sensing information. The electronic device may collect information (for example, fingerprint information) related to the authenticated user from a memory included in the electronic device or an external electronic device connected to the electronic device through a wired/wireless communication, and may compare the collected information with the analysis result. If the collected information is the same as or similar to the analysis result by a specific percentage or more, the electronic device may determine the user to be an authenticated person.

When it is determined that the user is an authenticated person, in step 780, the electronic device may successfully process the authentication. The electronic device may release a sleep state or unlock a screen. For example, the electronic device may allow the user to use the functional modules included in the electronic device or the functional modules included in the external electronic device connected to the electronic device through a wired/wireless communication, and may unlock a screen of the display 111 included in the electronic device or a display of an external electronic device connected to the electronic device through a wired/wireless communication.

When it is determined that the user is not an authenticated person, in step 790, the electronic device may perform a failure of an authentication. According to an embodiment, the electronic device may maintain a sleep state or a locked state of a screen. Further, the electronic device may make a limitation such that only a specific functional module of the functional modules included in the electronic device may be used, while releasing the sleep state or unlocking the screen.

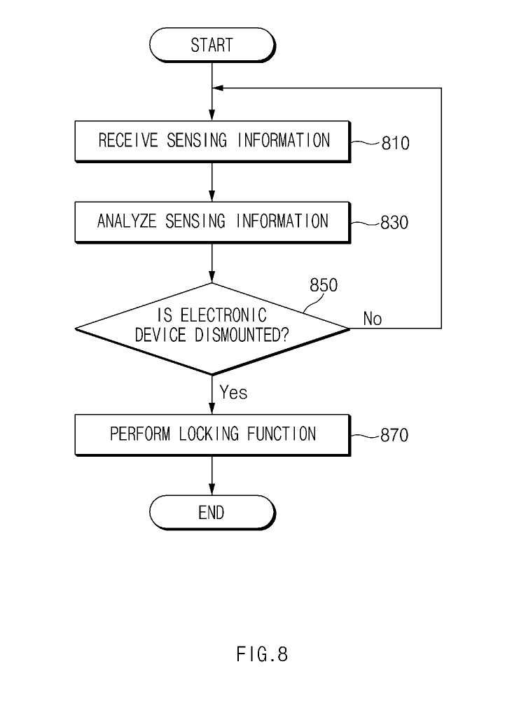

FIG. 8 is a flowchart of a security method of an electronic device when the electronic device is demounted from a user's body.

Referring to FIG. 8, when being dismounted, the electronic device 100 may perform a demounting function through the sensor module 170 disposed in a specific area of the binding device. For example, the electronic device may determine whether the electronic device is dismounted, by measuring a distance between a part of the body of the user and the electronic device through a proximity sensor.

In step 810, the electronic device may receive sensing information. According to an embodiment, the sensor module may detect the existence of an object that approaches a detection surface or an object existing in the vicinity of the detection surface at a time interval. In some embodiments, when the user does not wear an electronic device, the electronic device may be configured not to receive sensing information by turning off the sensor module. For example, if a user authenticating operation (for example, step 770 and step 780, or step 770 and step 790) described with reference to FIG. 7 is not performed, the electronic device may turn off the sensor module, and if the user authenticating operation is performed, the electronic device may turn on the sensor module.

In step 830, the electronic device may receive the sensing information. According to an embodiment, the electronic device may analyze a location of the mounting target. For example, the electronic device may analyze a distance and a direction of the electronic device from the mounting target.

In step 850, the electronic device may determine whether the electronic device is dismounted from the mounting target, based on the analysis result of the sensing information. According to an embodiment, the electronic device may determine that the electronic device is dismounted if it is identified that the electronic device is separated from the mounting target by a specific distance or more. Even when the electronic device is not spaced apart from the mounting target by a specific distance or more, it may be determined that the electronic device is dismounted when the spacing direction deviates from a specific angle range.

According to various embodiments, if it is determined that the electronic device is not dismounted, the electronic device 810 may return to step 810. If it is determined that the electronic device is dismounted, in step 870, the electronic device may perform a locking function. For example, the electronic device may lock a screen. Further, the electronic device may switch the state of the electronic device into a sleep state or may turn off a power source.

As described above, according to various embodiments, there is provided a security processing method of an electronic device, including sensing biometric information of a user by a sensor module disposed on a surface of a binding device connected to a body of the electronic device, which faces a mounting target, analyzing the sensed biometric information, and performing a user authenticating function based on the analyzed sensed biometric information.

According to various embodiments, the sensing of the biometric information of the user includes collecting at least one of fingerprint information, vein information, and electrocardiogram information of the user.

According to various embodiments, analyzing the sensed biometric information includes comparing the sensed biometric information with authentication information collected from at least one of a memory provided in the electronic device and an external electronic device connected to the electronic device through a wired/wireless communication.

According to various embodiments, performing the user authenticating function includes at least one of releasing a sleep state and unlocking a screen of at least one of the electronic device and an external electronic device connected to the electronic device through a wired/wireless communication, when it is determined that the user is an authenticated user.

According to various embodiments, performing the user authenticating function includes performing at least one of maintaining a current state and applying a limitation of function modules of at least one of the electronic device and an external electronic device connected to the electronic device through a wired/wireless communication, when it is determined that the user is not an authenticated user.

According to various embodiments, sensing the biometric information of the user includes measuring a distance between a proximity sensor included in the sensor module and the mounting target at a time interval. The proximity sensor may be disposed on a surface of the binding device, which faces the mounting target.

According to various embodiments, the security processing method may further include determining whether the electronic device is demounted, based on the measured distance between the proximity sensor and the mounting target, and performing a security processing based on the determination.

According to various embodiments, determining whether the electronic device is demounted includes determining that the electronic device is demounted, when the distance between the proximity sensor and the mounting target exceeds a specific distance or a direction thereof deviates from a specific range.

According to various embodiments, performing the security processing includes at least one of locking a screen, switching off a power source, and converting a current state into a sleep state of at least one of the electronic device and an external electronic device connected to the electronic device through a wired/wireless communication, when it is determined that the electronic device is demounted.

According to various embodiments, the security processing method may further include deactivating the sensor module when it is determined that the electronic device is demounted, and activating the sensor module when it is determined that the electronic device is mounted.

The term “module” used herein may refer to a unit including, for example, one of hardware, software, or firmware or a combination of thereof. The term “module” may be interchangeably used with the terms such as, unit, logic, logical block, component, or circuit. The module may be a minimum unit or a part of an integrally configured part. The module may be a minimum unit or a part which performs one or more functions. The module may be implemented mechanically or electromagnetically. For example, the module may include at least one of an application-specific integrated circuit (ASIC) chip, a field-programmable gate array, or a programmable-logic device, which has been known or will be developed in the future, or which performs certain operations.

At least some of the devices (for example, modules or functions) or methods (for example, operations) according to various embodiments of the present disclosure may be implemented by an instruction stored in a computer-readable storage medium, for example, in the form of a program module. When the instruction is executed by the processor, the at least one processor may perform a function corresponding to the instruction. The computer-readable storage medium may be a memory.

The computer-readably storage medium includes a hard disk, a floppy disk, a magnetic medium (for example, a magnetic tape), an optical medium (for example, a compact disk read only memory (CD-ROM)), a digital versatile disk (DVD), a meneto-optical medium (for example, a floptical disk), a hardware device (for example, a read only memory (ROM), a random access memory (RAM), or a flash memory). Further, the program instructions may include high-level language codes which may be executed by a computer using an interpreter as well as machine languages created by using a compiler. The above-mentioned hardware device may be configured to be operated as one or more software module to perform operations of various embodiments, and the converse is true.

The module or program module according to various embodiments of the present disclosure may include at least one of the above-mentioned element, omit some of them, or further include other elements. The module, the program module, or the operations performed by other elements may be performed in a sequential, parallel, iterative, or heuristic method. Further, some operations may be executed in another sequence or may be omitted, or other operations may be added. Further, the embodiments disclosed herein are provided to describe the technical contents or for understanding of the technical contents, and the technical scope of the present disclosure is not limited thereto. Accordingly, the scope of the present disclosure should be construed to include all changes or various embodiments based on the technical spirit of the present disclosure, and is defined, not by the detailed description and embodiments, but by the following claims and their equivalents.

What is claimed is:

1. An electronic device comprising:
a body; and
a binding device extending from the body to surround a mounting target,
wherein the binding device includes a sensor module, and
wherein the sensor module includes at least one first sensor disposed on a first surface of the binding device to sense a portion of the user's body to collect sensing information.

2. The electronic device of claim 1, wherein the binding device comprises a buckle, and the sensor module is disposed in the buckle.

3. The electronic device of claim 1, wherein the sensor module includes at least one second sensor disposed on a second surface of the binding device to measure a distance between the sensor module and the mounting target at a time interval, and
wherein the body determines whether the electronic device is demounted based on the measured distance between the sensor module and the mounting target.

4. A binding device for an electronic device, comprising:
a body seating part on which a body of the electronic device is seated;
a strap extending from the body seating part to surround a mounting target;
a sensor module disposed in the strap; and
a body connector disposed in an area of the strap, connected at a first end to the sensor module, and exposed to the outside through an opening formed on one surface of the body seating part, wherein the body connector is to be connected at a second end to the body of the electronic device.

5. The binding device of claim 4, wherein the sensor module is disposed in a buckle formed in an area of the strap.

6. The binding device of claim 5, wherein the sensor module includes a fingerprint recognition sensor, and the fingerprint recognition sensor is disposed on a surface of the buckle, which is opposite to a surface of the buckle that faces the mounting target.

7. The binding device of claim 5, wherein the sensor module includes a proximity sensor, and the proximity sensor is disposed on a surface of the buckle, which faces the mounting target.

8. The binding device of claim 4, wherein a battery is further disposed in the strap, and the battery is connected to at least one of the body connector and the sensor module.

9. The binding device of claim 4, wherein the body connector is a pogo connector comprising at least one pogo pin.

10. A security processing method of an electronic device, comprising:
sensing biometric information of a user by at least one sensor included in a sensor module,
wherein the at least one sensor is disposed on a first surface of a binding device connected to a body of the electronic device;
analyzing the sensed biometric information; and
performing a user authenticating function based on the analyzed sensed biometric information.

11. The security processing method of claim 10, wherein sensing the biometric information of the user comprises collecting at least one of fingerprint information, vein information, and electrocardiogram information of the user.

12. The security processing method of claim 10, wherein analyzing the sensed biometric information comprises comparing the sensed biometric information with authentication information collected from at least one of a memory provided in the electronic device and an external electronic device connected to the electronic device.

13. The security processing method of claim 10, wherein performing the user authenticating function comprises, when it is determined that the user is an authenticated user, performing at least one of releasing a sleep state and unlocking a screen of at least one of the electronic device and an external electronic device connected to the electronic device.

14. The security processing method of claim 10, wherein performing the user authenticating function comprises, when it is determined that the user is not an authenticated user, performing at least one of maintaining a current state and applying a limitation of functional modules of at least one of the electronic device and an external electronic device connected to the electronic device.

15. The security processing method of claim 10, further comprising measuring a distance between a proximity sensor included in the sensor module and the mounting target at a time interval,
wherein the proximity sensor is disposed on a second surface of the binding device.

16. The security processing method of claim 15, further comprising:
determining whether the electronic device is demounted, based on the measured distance between the proximity sensor and the mounting target; and
performing a security processing based on the determination.

17. The security processing method of claim 16, wherein determining whether the electronic device is demounted comprises determining that the electronic device is demounted, when the distance between the proximity sensor and the mounting target exceeds a specific distance.

18. The security processing method of claim 16, wherein performing the security processing comprises, when it is determined that the electronic device is demounted, performing at least one of locking a screen, switching off a power source, and converting to a current state into a sleep state of at least one of the electronic device and an external electronic device connected to the electronic device.

19. The security processing method of claim 18, further comprising:
deactivating the sensor module, when it is determined that the electronic device is demounted; and
activating the sensor module, when it is determined that the electronic device is mounted.
